(19) United States
(12) Patent Application Publication
(10) Pub. No.: US 2011/0214334 A1
(43) Pub. Date: Sep. 8, 2011

(54) Artificial Bait Trailer Retainer

(75) Inventor: Timothy Jon DeMarais, North Branch, MN (US)

(73) Assignee: FISHING DREAMS, LLC, North Branch, MN (US)

(21) Appl. No.: 13/038,829

(22) Filed: Mar. 2, 2011

Related U.S. Application Data
(60) Provisional application No. 61/404,941, filed on Oct. 12, 2010.
(60) Provisional application No. 61/341,969, filed on Apr. 7, 2010.
(60) Provisional application No. 61/339,432, filed on Mar. 4, 2010.

(51) Int. Cl. A01K 91/04

(52) U.S. Cl. 43/43.1

(57) ABSTRACT

A device attachable to an artificial fishing lure to prevent an artificial trailer bait from sliding down the lure's fish hook comprises a piece of wire that is preformed into a generally U-shape exhibiting a pair of legs joined by a base segment and where the terminal portion of each of the legs is turned inward towards its opposed leg. Depending on the type of artificial lure employed, the base segment of the U-shape piece of wire is formed to suit the application.

### CROSS REFERENCE TO RELATED APPLICATIONS

The present application claims priority to previously filed provisional patent application Ser. No. 61/404,941, filed Oct. 12, 2010; Ser. No. 61/341,969, filed Apr. 7, 2010; and Ser. No. 61/339,432, filed Mar. 4, 2010, each of which is hereby incorporated by reference.

### BACKGROUND OF THE INVENTION

I. Field of the Invention

This invention relates generally to fishing lures, and more particularly to a device for preventing an artificial trailer bait from slipping down the shank of a fishhook on an artificial bait.

II. Discussion of the Prior Art

Bass fishing is a highly popular recreational activity and a variety of artificial lures has been marketed and is known in the art for use in fishing bass. One such lure is referred to as a “flippin' jig”. It comprises a lead sinker with a hook molded into it and with a skirt formed from a plurality of silicone rubber fibers of various colors thought to attract fish. Such jigs are intended to create a jerky, vertical motion as opposed to so-called “spinner baits” which are designed to move horizontally through the water.

Other jig baits comprise an artificial lure again with a weight at an upper end of the hook's shank and with a rubber or silicone shape to resemble a grub worm, a frog, a minnow or other shapes thought to be attractive to bass.

It is also a common practice for bass fishermen to add a further attractant to an artificial bait referred to as a “trailer”. The trailer is designed to follow behind the lure's hook and wiggle as the lure is made to travel through water as the fisherman reels in a cast. A trailer also can be used to slow the descent of a jig following a cast.

A typical trailer may be made to resemble a worm, a crawfish, a frog with splayed out legs or other bass prey. A trailer is generally threaded onto the lure's hook and made to ride up the shank of the hook so that the head end of the trailer abuts the eye on the end of the hook opposite its point and barb. In this position, it tends to obscure the hook while still adding the trailer's functionality as a fish attractant.

A problem that has persisted is that when the jig-type lure is made to travel through a weed bed where bass tend to feed, the trailer tends to slip down the shank of the hook and free of the lure.

Another type of artificial lure is referred to as a “Texas rig”. These lures are particularly popular for large mouth bass fishing, along with other species of game fish, including small mouth bass, walleyes and perch. Because the Texas rig is weedless, it is particularly good for fishing in heavy cover. The rig has a weight that slides freely when a fish strikes, reducing the resistance on the line and tricking the fish into holding the bait for a few extra seconds that allow the fisherman to set the hook.

The tackle required for a Texas rig includes a specially designed worm hook that has an offset bend in the shank just below the eye, and a soft plastic bait such as a silicone worm, a grub or a lizard. A fisherman can vary the size of the worm and the weight to change the rate of fall of the bait through the water and one can fish it as slowly or as quickly as he/she may want.

The first step in creating a Texas rig is to slip a bullet sinker onto the line by inserting the line into the pointed end of the sinker. Next, an offset worm hook is tied onto the fish line. Once this is done, the worm is threaded onto the hook by forcing the head end of the worm over the hook and barb and forward to the rounded base of the hook. The hook point is then made to exit the worm at the side of its head. Next, the head portion of the worm is slid up the hook towards the eye while twisting the worm around the shank so that the point of the hook is facing the worm. The worm is allowed to hang straight down while the thumb and forefinger are used to squeeze the worm at a location just below the rounded base of the hook. While keeping the thumb and forefinger on that spot, the worm is bent so that the point of the hook can be inserted into the worm at substantially a right angle. Next, the point of the hook is pushed all the way through the worm. With this step completed, the worm makes a straight line between the point of the hook and its eye. Next, the worm is moved slightly so that the point of the hook is slipped just under the surface of the plastic. At this point, the Texas rig is called “weedless” in that the lure can slip through weeds without getting snagged.

The advantage of the Texas rig is lost if the head end of the worm is allowed to slip down the shank of the hook.

The present invention provides a device for preventing an artificial bait or trailer from slipping down the shank of a fishhook thus preserving the position of the lure trailer over repeated casts, even into weed beds and heavier cover.

### SUMMARY OF THE INVENTION

The present invention provides a device that is attachable to a fishing lure to prevent an artificial trailer bait from sliding down the lure's fishhook. In accordance with the preferred embodiment, a piece of wire that is preformed by bending into a generally U-shape so as to exhibit a pair of legs joined by a base segment and with a terminal portion of each leg turned inward toward its opposing leg is appropriately attached to a fishing lure such as, for example, to the eye of the hook and then manipulated such that the inwardly turned terminal portion of each leg is adapted to penetrate into and hold the artificial trailer bait in place on the fishhook.

In one embodiment, the piece of wire is preferably a stainless steel material exhibiting resilient properties and a closed loop is formed in the base segment where the loop is expandable and contractible by squeezing such that it can be made to fit over and clamp onto a collar commonly used to secure the fishhook to an artificial lure.

In an alternative embodiment for use with a Texas rig bait, the base segment of the bent wire piece is generally straight and in yet another embodiment, the base segment is U-shaped and bent at an angle to a plane defined by the pair of legs of the device.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which like numerals in the several views refer to corresponding parts.

FIG. 1 is an isometric view of a trailer hitch device in accordance with a first embodiment of the present invention;

FIG. 2 illustrates the manner in which the trailer hitch device is assembled onto a jig-type lure;

FIG. 3 shows my trailer hitch in position about the collar of the lure of FIG. 2;

FIG. 4 illustrates the way the trailer hitch of FIG. 1 secures an artificial bait in place;

FIG. 5 is a view showing a flippin' jig lure with a trailer added and held in place with my trailer hitch device;

FIG. 6 illustrates a plan view of an alternative embodiment;

FIG. 7 is a side view of the embodiment of FIG. 6;

FIG. 8 illustrates a weighted hook with which the embodiment of FIG. 6 may be used;

FIG. 9 illustrates an artificial trailer bait assembled onto the weighted hook of FIG. 8 and with my alternative hitch arrangement used to secure the bait in place;

FIG. 10 is a top view of the arrangement shown in FIG. 9;

FIG. 11 is a second alternative embodiment of a trailer hitch for use with a Texas rig;

FIG. 12 is a view showing the embodiment of FIG. 11 being inserted through the artificial bait and hook during creation of a Texas rigged bait;

FIG. 13 illustrates the use of my embodiment of FIG. 11 to secure the artificial bait in place on the hook; and

FIG. 14 is a view of a Texas rigged bait held in place with respect to the hook using my alternative hitch embodiment of FIG. 11

### DESCRIPTION OF THE PREFERRED EMBODIMENTS

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

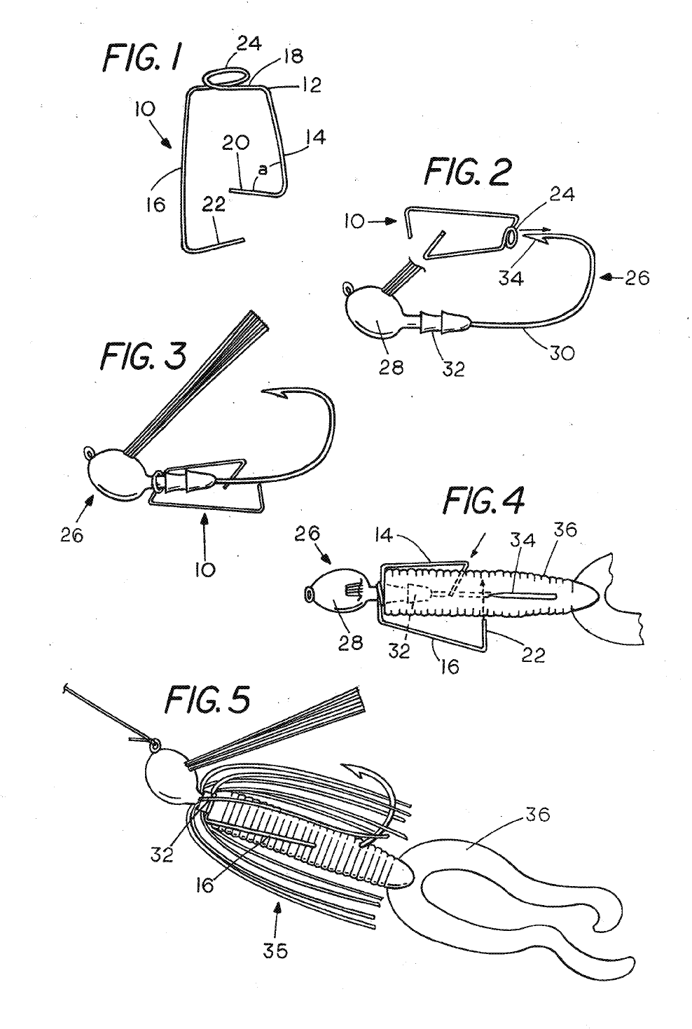

Referring initially to FIG. 1, there is shown a first embodiment of what is referred to herein as a trailer hitch, the purpose of which is to secure an artificial trailer bait onto the hook of a lure to prevent the trailer bait from sliding down the shank of the hook. It is identified generally by numeral 10 and is seen to comprise a piece of wire 12 that is preformed into a generally U-shape exhibiting a pair of legs 14, 16 joined by a base segment 18. Leg 16 is slightly longer than leg 14. The free end or terminal portion 20 and 22 of each leg 14, 16 is bent inward toward its opposed leg at an acute angle. That is to say, the leg 14 has its terminal portion 20 bent so as to point toward leg 16 while the terminal portion 22 of leg 16 is bent and directed toward the leg 14 and at an angle, a, of less than 90°.

In the embodiment of FIG. 1, the base segment 18 is bent so as to define a loop 24.

The wire 12 is preferably stainless steel so as to exhibit a resilient or spring-like property so that pinching the legs 14 and 16, the loop 24 will increase in diameter and when the pinching force is removed, it will return to its unstressed shape.

FIG. 2 illustrates a jig head hook 26 having a lead weight 28 affixed to the terminal end of the hook's shank 30 and having a collar 32 to which an artificial bait may be secured as is well known in the art.

With continued reference to FIG. 2, the trailer hitch 10 is assembled onto the hook by passing the pointed and barbed end of the hook 34 through the loop 24 and then passing the trailer hitch 10 up the shank 30 at which point the legs 14 and 16 are pinched to open the loop 24 to a larger diameter allowing it to fit over the collar 32. Once the pinch force is relieved, the loop recloses to a lesser diameter so as to be captured on the collar 32. The hitch 10 mounted on the jig head hook is illustrated in FIG. 3.

In FIG. 4 there is shown an artificial trailer bait 36 molded or extruded from a soft plastic such as silicone rubber that has been threaded onto the hook 26 so that its head end is in covering relation with respect to the collar 32 and with the terminal portion 20 of the leg 14 piercing into the body of the artificial bait 36. In FIG. 4, the leg 16 is about to be squeezed and deformed so that the terminal portion 22 of that leg will penetrate into the silicon rubber artificial lure body 36.

When so inserted, the trailer bait 36 is securely held in place on the shank of the hook and is unable to slide relative thereto, being held by the trailer hitch 10.

FIG. 5 illustrates how the trailer bait 36 can be added to a jig head hook arrangement on which a skirt 38 comprising a plurality of strands of various colors may be added to the assembly to create a so-called “flippin' jig” artificial lure. The skirt is appropriately tied or otherwise affixed to the collar 32 of the jig head hook 26. The leg 16 of my trailer hitch is also seen in the view of FIG. 5.

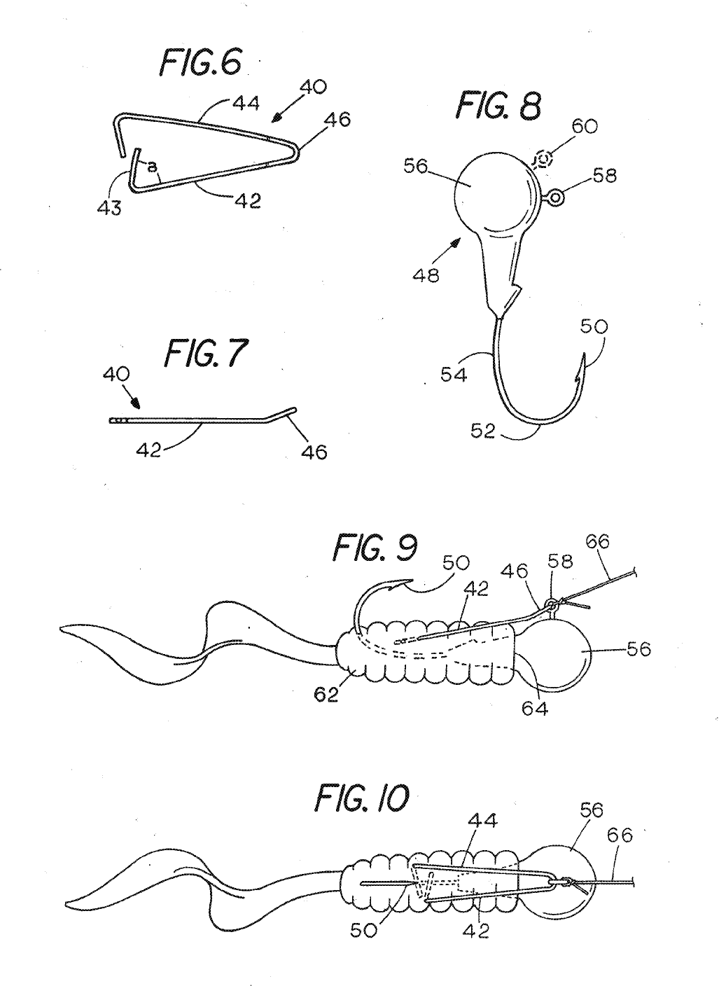

FIG. 6 illustrates an alternative embodiment especially designed for use with a jig head hook. Again, the bait hitch comprises a piece of wire 40 that is preformed into a generally U-shape and exhibiting a pair of legs including legs 42 and 44. It can be seen that leg 44 is longer than the leg 42. The pair of legs is joined by a base segment 46 and as is seen in the side view of FIG. 7, the base segment is at an angle to a plane defined by the pair of legs 42 and 44. The wire used in forming the bait hitch 40 is again preferably a resilient stainless steel although other materials may be used as well, so long as they possess the requisite resiliency.

FIG. 8 illustrates a jig head hook and it is identified generally by numeral 48. It comprises a fish hook having a pointed end and barb 50, a rounded or U-shaped base portion 52 and a shank 54 that terminates at its proximal end with a weight of a predetermined shape configuration. The weight is identified by numeral 56. Projecting outward from the weight is an eye 58 to which a fish line or leader is adapted to be secured. Some jig head hooks may have the eye located as indicated by the broken line eye 60. As can be seen in FIGS. 9 and 10, an artificial trailer bait, usually of silicon rubber and identified by numeral 62, has its head end 64 pierced by the pointed end 50 of the hook and the trailer bait 62 is then slid up the shank 54 of the hook so as to abut the weighted end 56. A segment of fishing line or leader 66 is connected to the eye 58 and the bait hitch member 40 is also passed through the eye 58 such that the U-shaped base thereof resides in the center of the eye. Because of the angle at which the base 46 is bent, the leg 42 overlays the trailer bait 62 when the base 46 is disposed in the eye 58 allowing its terminal portion 43 to pierce into the material of the trailer bait 62. The view of FIG. 10 shows the terminal portions of the legs 42 and 44 both inserted into the material of the trailer bait, thus preventing the trailer bait from slipping down the shank 54 of the hook.

FIG. 11 is a plan view of a trailer hitch especially designed for use with a Texas rigged artificial bait. Again, the Texas rig hitch device comprises a piece of wire 70 that is bent or otherwise formed into a generally U-shape exhibiting a pair of legs 72 and 74, each with a terminal end 76, 77 turned inward at an acute angle, a, so as to point toward its opposed leg. The legs are joined by a base portion 80 that is generally straight.

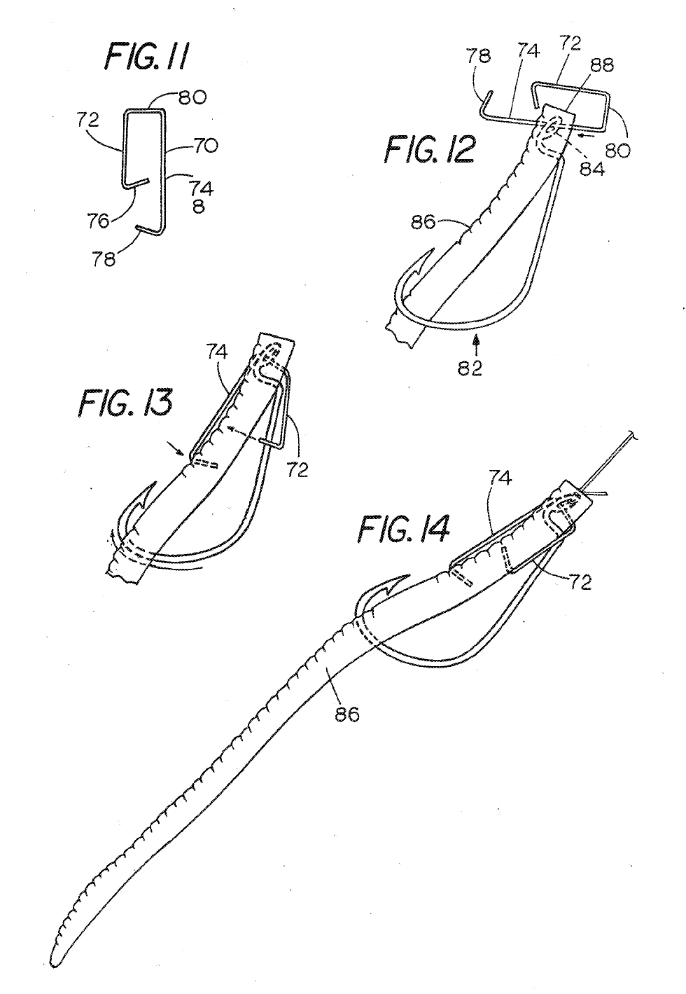

The hook 82 used in a Texas rigged bait has an offset eye 84 at its proximal end. An artificial bait, such as a silicone rubber worm 86, is shown as having been assembled to the hook as previously described beginning at page 2, supra, and the head end of the worm 88 is fed up the shank to the point where the eye 84 thereof is buried in the head end portion of the worm 88. To secure it in place, the hitch device of FIG. 11 is made to pierce through the sidewall of the plastic worm bait at its head end and to pass through the eye 84 of the hook as seen in FIG. 12. Next, the user pinches the worm at a location falling just below the rounded base of the hook and then bends the bait at somewhat of a right angle allowing the point of the hook to pierce through the sidewall of the bait, whereupon the worm becomes threaded on the hook in the manner shown in FIG. 13. To secure the worm in place, the hitch member 70 is moved so that the base portion 80 thereof resides in the eye of the hook and then the legs 72 and 74 are squeezed together such that the inwardly turned terminal portions 76 and 78 become buried in the material of the artificial worm bait 86 thereby preventing the artificial bait from riding down the shank portion of the hook. At this point, the user may wish to shift the artificial bait slightly to the left when viewed in FIG. 14 so that the point and barb of the hook become contained within the body of the worm bait 86 thereby rendering the Texas rigged bait “weedless”. A bass striking the lure, however, will cause the point and barb of the hook to protrude and thereby snag the lip of the fish.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A device attachable to an artificial fishing lure to prevent an artificial trailer bait from sliding down the lure's fishhook comprising:
(a) a piece of wire that is preformed into a generally U-shape exhibiting a pair of legs joined by a base segment with a terminal portion of each leg turned inward toward its opposed leg; and
(b) a means for attaching the piece of wire to a fishing lure, the means being at a location generally midway between the pair of legs.

2. The device of claim 1 wherein the means for attaching comprises a closed loop formed on the base segment of the U-shaped piece.

3. The device of claim 2 wherein the closed loop is dimensioned to fit about a collar that secures the fishhook to the artificial lure.

4. The device of claim 3 wherein the terminal portion of each leg is adapted to penetrate into and hold the artificial trailer bait in place on the fishhook.

5. The device of claim 1 wherein the legs are of differing length.

6. The device of claim 1 wherein the wire is a stainless steel spring wire.

7. The device of claim 1 wherein the artificial lure is a jig and the means for attaching is a generally U-shaped base segment that is adapted to be fitted onto an eye of the jig, said U-shaped base segment being at an angle to a plane defined by the pair of legs.

8. The device of claim 7 wherein the terminal portion of each leg is adapted to penetrate into and hold the artificial trailer bait in place on the fishhook.

9. The device of claim 8 wherein the artificial trailer bait comprises silicone rubber.

10. The device of claim 1 wherein the terminal portion of each leg is turned inward toward its opposed leg at an acute angle.
